(19) United States
(12) Patent Application Publication
(10) Pub. No.: US 2008/0173764 A1
(43) Pub. Date: Jul. 24, 2008

(54) Out-door jacket connected parachute for low altitude deployment

(76) Inventor: Yeung Sung Oh, Los Angeles, CA (US)

Correspondence Address: YEUNG SUNG OH, 340 S. Van Ness Avenue, Los Angeles, CA, 90020, US

(21) Appl. No.: 11/656,368

(22) Filed: Jan. 23, 2007

(51) Int. Cl. B64D 17/00

(52) U.S. Cl. 244/143

(57) ABSTRACT

A parachute for low altitude deployment is provided. The parachute of the current application is comprised of a canopy formed of pieces of fabric sewed together, pluralities of HDPE (High Density Poly Ethylene) film tubes, reinforced with sheaths made of same material of the canopy, extending from the center of the canopy in a spoke-wise manner, a connector which has pluralities of arms that are connected to the HDPE film tubes reinforced with sheaths made of same material of the canopy, a compressed air container, a HDPE film tubes reinforced with sheaths made of same material of the canopy that connects the compressed air container and the connector, and a harness firmly attached to an out-door jacket.

### FIELD OF THE INVENTION

The present invention relates generally to a life parachute, and particularly to a wearable life parachute as an out-door jacket for low altitude deployment.

### BACKGROUND OF THE INVENTION

In spite of various parachutes known today in a number of documents including patients, there is only few type of parachute available. One type is a traditional parachute for military purpose. To use that parachute, a wearer, usually a soldier must be trained for jump and has to carry a bulky bundle of support that comprises of many belts and hard frame and seat. Second type is a gliding parachute. The gliding parachute usually has a wing shape canopy and many kind of gliding control mechanisms are additionally attached to the support of the parachute. Both types of parachutes are inflated by high speed wind that encounters with the parachute. In addition to the two types of parachutes, many kind new parachutes are introduced that are suitable for low altitude jumping. Those low altitude jumping parachutes utilize compressed air to inflate the canopy forcefully. For those parachute, the wearing part, vest/harness, is still massive and it takes time to wear them properly. Those parachutes are normally stored in a separate place before they are used intendly. It is purpose of the current invention to provide a more convenient and wearable parachute, wearable just like an out-door jacket. The wearer can board civil air liners without a fear of plane crash or jump out of the window of a skyscraper when a fire breaks out.

### DESCRIPTION OF PRIOR ARTS

U. S. Patent Application 20050087653 to Koch illustrates a parachute. The canopy is provided with a ring shape hose device for rapid unfurling and preferably stabilizing. The device is fixed to the parachute and comprises a rapidly-inflating inflation system, airbag systems. But, the ring shaped hose 30 and its inflating system of gas generator are too bulky for emergency life saving system.

U. S. Patent Application 20050020393 to Straka, Josef illustrates a parachute that is adapted for deployment at low altitudes and low air speeds. Trapezoidal inflation pockets, sewn on the exterior of the bottom edge of alternating gores, help deployment of the canopy.

U.S. Pat. No. 5,161,755 to Tsay illustrates a parachute including a canopy formed of pieces of fabric sewed together, sheaths extending from the center of the canopy in a spoke-wise manner, and an inflatable envelope connected to a compressed gas container by way of a conduit. The inflatable envelope has a main body in the center thereof and legs extending spoke-wisely from the periphery of the main body; the legs and the main body are interconnected and inflatable. The free ends of the legs are inserted into the corresponding sheaths and then secured onto the canopy so that the main body of the inflatable envelope can be maintained at the central portion of the canopy. However, the legs may tear the sheaths and the canopy if a sudden pulse happens and the canopy is folded during descending. It is very dangerous situation.

U.S. Pat. No. 5,028,018 to Krebber illustrates a device for accelerating the opening of a canopy, square or gliding parachutes, among others, has an air space at the base and along the circumference of the canopy. The air space has for example the form of a hose or of an air-impervious hem which is under high air pressure in operative conditions, so that when the wrapper is opened this air space stretches out in a very short time and the aviation device opens after a fall of only 20-30 m. The air space (4) forms a circular ring when it is fully deployed along the circumference of the canopy. However, an angle, attached at one edge on the right and/or left-hand side for stiffening may tear the canopy when the parachute may face a sudden pulse and the canopy is folded during descending.

U.S. Pat. No. 4,562,981 to Smith, et al. illustrates a parachute assembly includes a canopy, a harness connected to the canopy by lines. Envelopes in the canopy defined by a plurality of generally triangular inflatable gussets extend from adjacent the apex to adjacent the basal perimeter and taper outwardly towards the basal perimeter. The assembly includes a source of pressurized gas and flexible conduits connecting the gas source to the gussets. If the gust are made of a material strong enough to sustain the high pressure from the gas chamber, it may be too heavy for a canopy of an emergency parachute. And the gas container needs too many valves to control the pressure of the gas that is supplied to the gussets.

U.S. Pat. No. 4,105,173 and U.S. Pat. No. 4,257,568 to Bucker disclose inflatable parachute comprising a canopy with a hole in the center; flexible conduits; gas container inflation; legs distributed under the canopy in a spoke-wise manner and capable of inflation; an envelope; and a jacket attached to the parachute's lines. However, Bucker does not solve the problem of connecting the canopy and the conduits and the solution to this problem are of utmost importance.

U.S. Pat. No. 4,793,575 to Butler illustrates a chest-mountable emergency parachute pack for crew members of an airplane when bailing out or when the plane is being ditched. Therefore, it does not need special deployment system.

None of the prior art illustrates a low altitude deployment parachute that is easy to wear and deploys quickly and safely as shown in the current application.

### SUMMARY OF THE INVENTION

In spite of various parachutes known today in a number of documents including patents, there is only few type of parachute available. One type is a traditional parachute for military purpose. To use that parachute, a wearer, usually a soldier must be trained for jump and has to carry a bulky bundle of support that comprises of many belts and hard frame and seat. Second type is a gliding parachute. The gliding parachute usually has a wing shape canopy and many kind of gliding control mechanisms are additionally attached to the support of the parachute. Both types of parachutes are inflated by high speed wind that encounters with the parachute. In addition to the two types of parachutes, many kind new parachutes are introduced that are suitable for low altitude jumping. Those low altitude jumping parachutes utilize compressed air to inflate the canopy forcefully. For those parachute, the wearing part, vest/harness, is still massive and it takes time to wear them properly. Those parachutes are normally stored in a separate place before they are used intendly. It is purpose of the current invention to provide a more convenient and wearable parachute, wearable just like an out-door jacket. The wearer can board civil air liners without a fear of plane crash or jump out of the window of a skyscraper when a fire breaks out. A parachute is provided which is comprised of a canopy formed of pieces of fabric sewed together, pluralities of HDPE (High Density Poly Ethylene) film tubes, reinforced with sheaths made of same material of the canopy, extending from the center of the canopy in a spoke-wise manner, a connector which has pluralities of arms that are connected to the HDPE film tubes reinforced with sheaths made of same material of the canopy, a compressed air container, a HDPE film tubes reinforced with sheaths made of same material of the canopy that connects the compressed air container and the connector, and a harness-firmly attached to an out-door jacket.

### BRIFE DESCRIPTION OF THE DRAWINGS

FIG. 1 is a perspective view of an out-door jacket connected parachute for low altitude deployment embodying the present invention.

FIG. 2 is an over view of the canopy of the out-door jacket connected parachute for low altitude deployment embodying the present invention.

FIG. 3 is a bottom view of the canopy of the out-door jacket connected parachute for low altitude deployment embodying the present invention.

FIG. 4-a is an enlarged perspective view of an HDPE firm tube reinforced with sheaths.

FIG. 4-b is a cross sectional view of the HDPE firm tube reinforced with sheaths attached to the canopy shown along the line A-A′ in FIG. 1.

FIG. 4-c is an enlarged perspective view of a connector which has pluralities of arms that are connected to the HDPE firm tubes reinforced with sheaths.

FIG. 4-d is a perspective view of the canopy of the parachute of the current invention when it is folded.

FIG. 5-a is a perspective view of inside of an out-door jacket wherein, a harness of the parachute embodying the current invention is attached.

FIG. 5-b is a front view of the out-door jacket of the low altitude deployment parachute embodying the current invention.

FIG. 5-c is a side view of the out-door jacket of the low altitude deployment parachute embodying the current invention.

### DETAILED DESCRIPTION OF THE PREFERRED EMBODIMENTS

Design concept of the current invention is to provide a low altitude deployment parachute that is easy to wear, compact, and deploy fast.

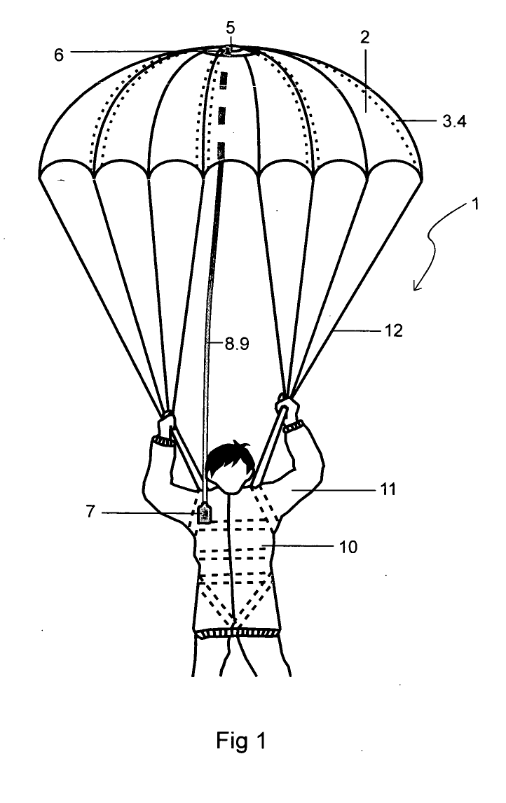

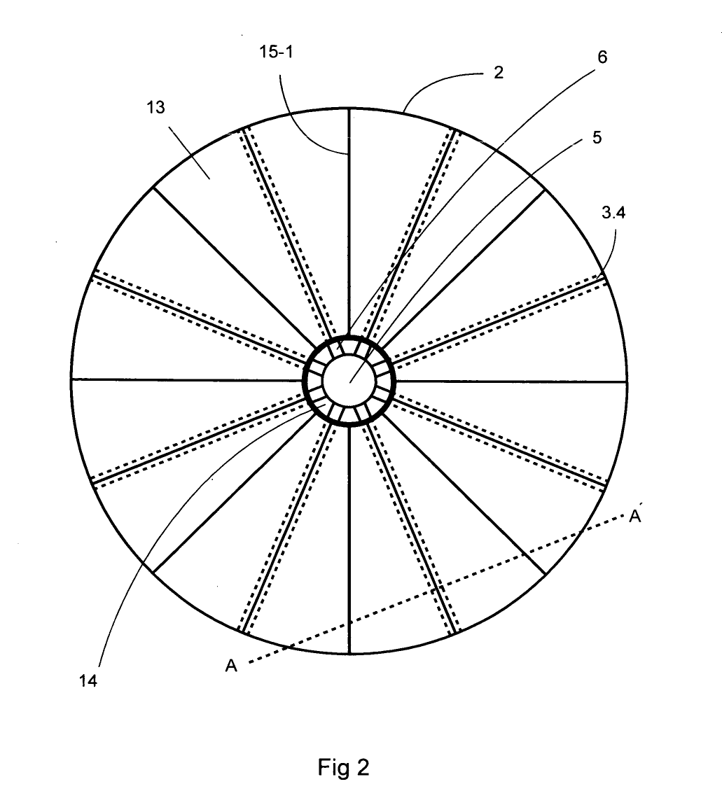

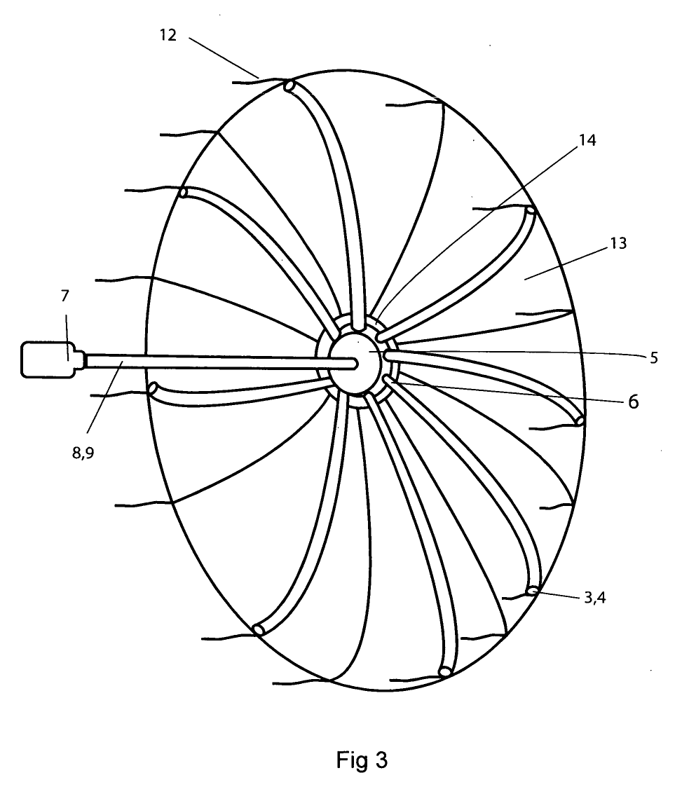

FIG. 1 is perspective view of an out-door jacket connected parachute (1) for low altitude deployment embodying the present invention. The parachute (1) of the current invention is comprised of a canopy (2) formed of pieces of fabric sewed together, pluralities of HDPE (High Density Ploy Ethylene) film tubes (3), reinforced with sheaths (4) made of same material of the canopy (2), extending from the center of the canopy in a spoke-wise manner; a connector (5) which has pluralities of arms (6) that are connected to the HDPE film tubes (3) reinforced with sheaths (4) made of same material of the canopy (2); a compressed air container (7); a long HDPE film tubes (8) reinforced with sheath (9) made of same material of the canopy (2) that connects the compressed air container (7) and the connector (5); and a harness (10) firmly attached inside of an out-door jacket (11) Pluralities of rigging lines (12) connect the canopy (2) and the harness (10).

FIG. 2 is an overview of the canopy (2) of the out-door jacket (11) connected parachute (1) for low altitude deployment embodying the present invention. The canopy (2) is formed of pieces of fabric (13) sewed together. The canopy (2) has a hole (14) at the center thereof to allow air pass through.

FIG. 3 is a bottom view of the canopy (2) of the out-door jacket (11) connected parachute (1) for low altitude deployment embodying the present invention. A connector (5), which has pluralities of arms (6) that are connected to the HDPE (High Density Poly Ethylene) film tubes (3) reinforced with sheaths (4) made of same material of the canopy, locates at the center of the canopy inside of thereof. Pluralities of HDPE (High Density Poly Ethylene) film tubes (3), reinforced with sheaths (4) made of same material of the canopy (2), extends from the connector (5) in a spoke-wise manner. A long HDPE film tubes (8) reinforced with sheaths (9) made of same material of the canopy (2) connects the compressed -air container (7) and the connector (5).

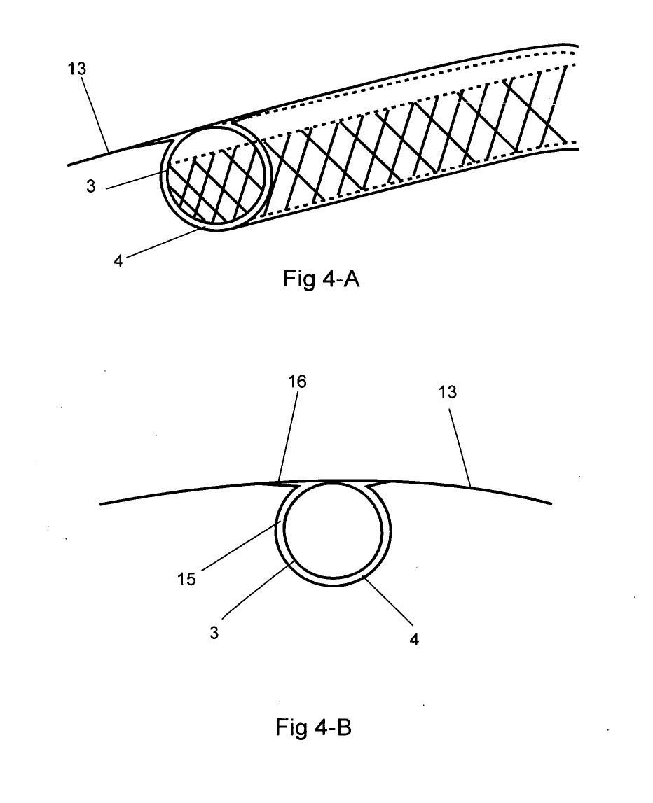

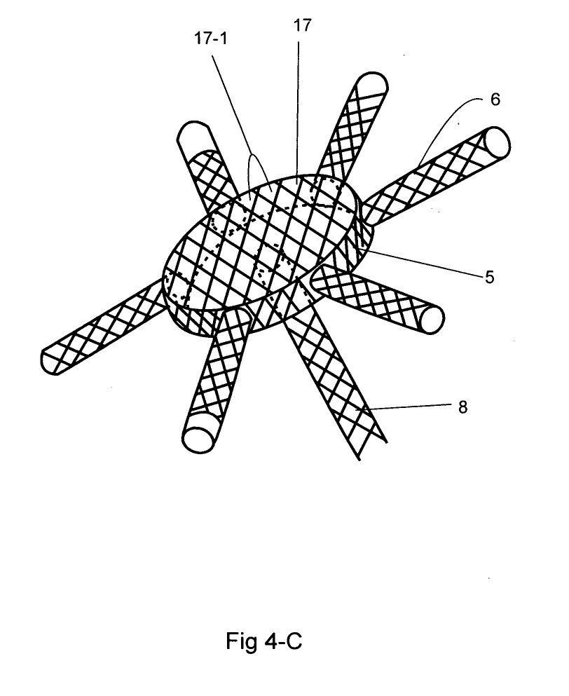

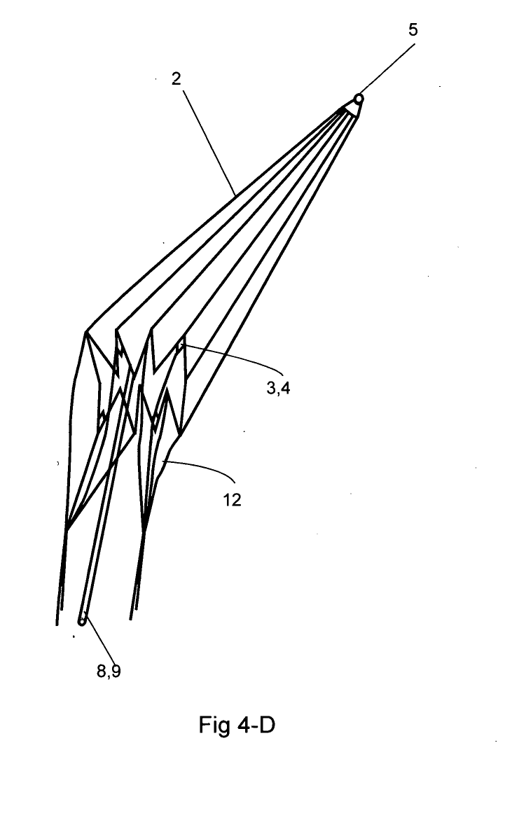

FIG. 4-a is an enlarged perspective view of an HDPE film tubes (3) reinforced with sheaths (4) made of same material of the canopy (2) of the parachute (1) of present invention.

HDPE film bag is easily found from a grocery corner of a supermarket. HDPE film is well known for its low permeability of gas and air compared with the thickness of the film and high tears strength. Typical thickness of HDPE film on the market is 30 micrometer. That is one tenth ( 1/10) of the thickness of a paper. The thickness can be reduced down to 10 micrometer. Therefore, weight of a HDPE film bag is negligible. HDPE is easily fabricated as a tube film type by extrusion method.

Diameter of the tube is from 2 cm to 900 cm. The only weak point is that it can be easily stretched and deforms by pressure. Meanwhile, material for canopy of a parachute is usually Nylon®, which has good resilient strength and tear strength. It can hold the HDPE film in a blown form. Therefore, combination of HDPE film tube and Nylon® sheath produce a tube that is very flexible, very light, very compact, and blocks air.

FIG. 4-b is a cross sectional view of the HDPE film tube (3) reinforced with sheaths (4) attached to the canopy (2) shown along the line A-A′ in FIG. 1 HDPE film tube (3) and Nylon® sheath (4) are adhered by heat sealing with a hot melt sealant (15) of EVA (Ethylene Vinyl Acetate copolymer) or EAA (Ethylene Acrylic Acid copolymer) from Du Pont. Heat sealed portion is 75% of circumference of the HDPE film tube (3), marked as crossed. Part (16) of sheath, that is not adhered to the HDPE film tube (3) are stitched to the fabric (13) of the canopy (2) along the sewing line (15). Number of sewing lines (15) is grater than the number of HDPE film tubes (3) reinforced with sheaths (4). Preferably, number of sewing lines (15) is twice the number of HDPE film tubes (3).

FIG. 4-c is an enlarged perspective view of a connector (5) which has pluralities of arms (6) that are connected to the HDPE film tubes (3) reinforced with sheaths (4). The connector (5) is also made of HDPE film drum (17) reinforced with same fabric (17-1) of the canopy (2). The arms (6) are also made of HDPE film tube (3) reinforced with sheaths (4). For the long HDPE film tube (8) for compressed air conduit and the arms (6), the film tube (3) is wholly surrounded with sheaths (4).

FIG. 4-d is a perspective view of the canopy (2) of the parachute (1) of the current invention when it is folded. Since the HDPE film tubes (3) and the sheath (4) are easily folded in a film shape, they return to layers of films when the air is removed or not introduced. Therefore, they occupy only negligible volume when a user fold and pack the canopy. Even the long HDPE film tubes (8) reinforced with sheaths (9) for conduit of the compressed air returns a stripe form.

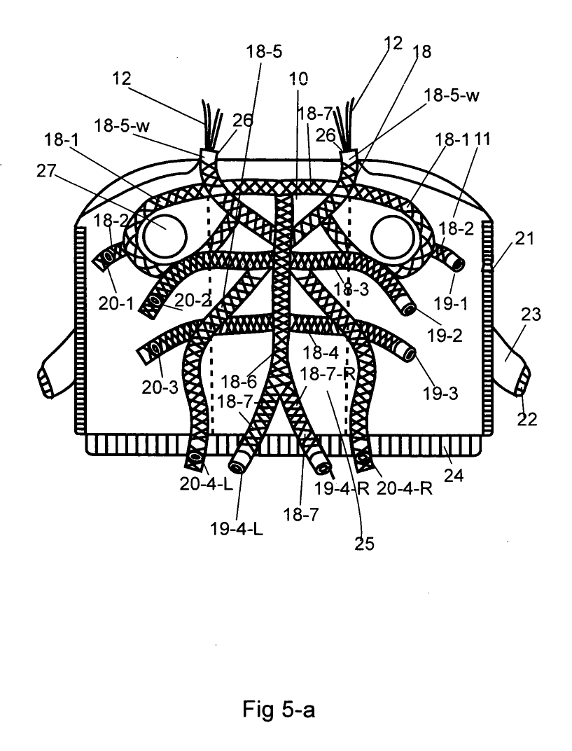

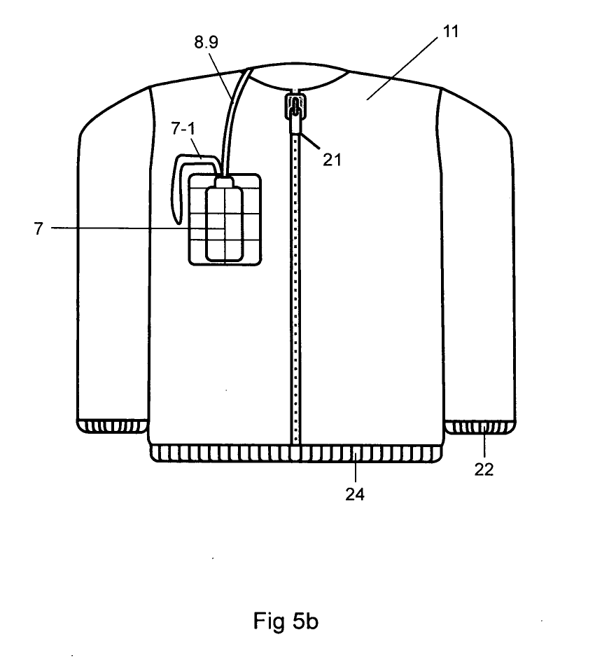

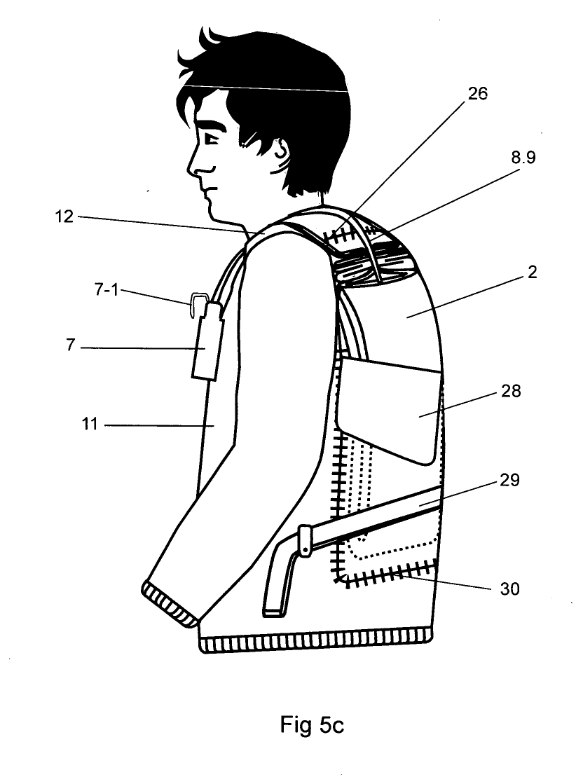

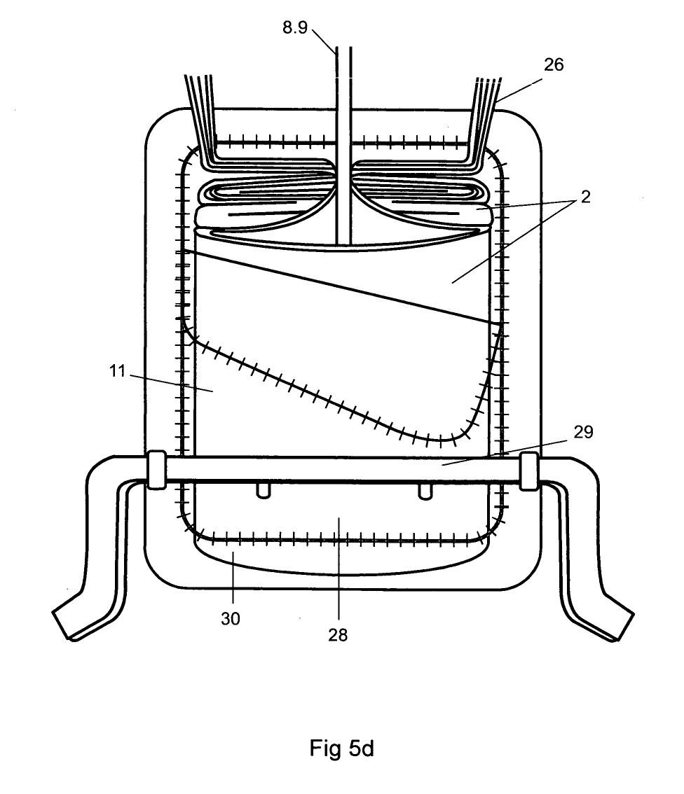

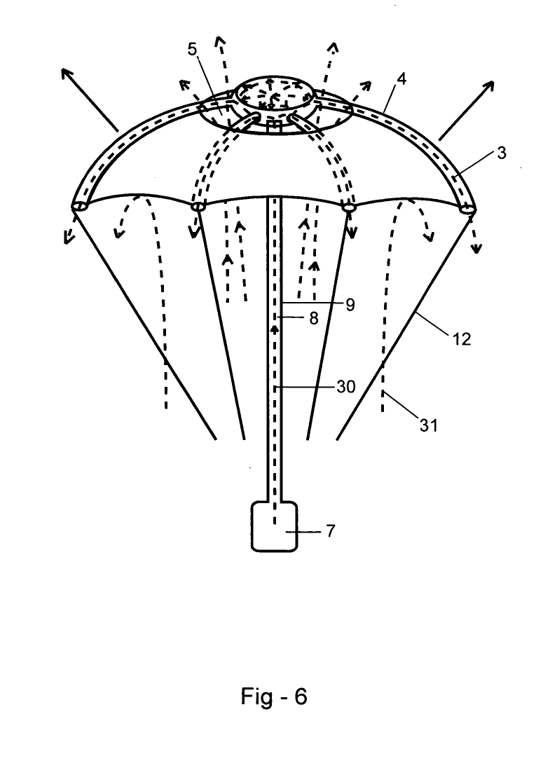

FIG. 5-a is a perspective view of inside of an out-door jacket (11), wherein a harness (10) of the parachute (1) embodying the current invention is attached. The harness (10) is comprised of belts (18), buckles (19), and latch plates (20). The belts (18) are stitched to the inside of the out-door jacket (11). The jacket (11) is closed by a zipper (21). End (22) of sleeves (23) and bottom (24) of the jacket (11) is made of elastic sleeve to prevent blow up of the jacket (11) itself by the wind. Two shoulder belts (18-1) are stitched to the inside of shoulder part of the jacket (11) along the circumference of the shoulder. Two shoulder branch belts (18-2). A chest belt (18-3) is horizontally stitched to the inside of the rear portion (25) of the jacket (11), just below the armpit of a wearer. 50 cm of both ends of chest belt (18-3) are not stitched and extended freely. A chest buckle (19-2) installed to one free end of the chest belt (18-3) and a chest latch plate (20-2) is installed on the other free end of the chest belt (18-3).

A waist belt (18-4) is horizontally stitched to the inside of the rear portion (25) of the jacket (11) on a waist portion. 50 cm of both ends of the waist belt (18-4) are extended feely. A waist buckle (19-3) is installed on one free end of the waist belt (18-4) end and a waist latch plate (20-3) is installed on the other free end of the waist belt (18-4).

Two cross belts (18-5) are stitched to the inside of the rear portion (25) of the jacket (11) by crossing each other as “X” shape. Upper ends (18-5-W) of both of the cross belts (18-5) are connected to bundle holder (26) of the rigging lines (12). 50cm of both lower ends (18-5-L) of the cross belts (18-5) are extended freely. A cross latch plate (204-L) is installed on a free lower end that locates at the left side of the drawing and another cross latch plate (20-4-R) is installed on a free lower end that locates at the right side of the drawing.

A back spinal belt (18-6) is vertically stitched to the center of the inside of the rear portion (25) of the jacket (11). Upper end of the back spinal belt (18-6) meets with a horizontal belt (18-7) that horizontally connects upper portions of the two shoulder belts (18-1). Lower end of the back spinal belt (18-6) is divided into two leg belts (18-7-L) and (18-7-R). A leg latch plate (19-4-L) is installed at the end of the leg belt (18-7-L) and another leg latch plate (19-4-R) is installed at the end of the other leg belt (18-7-R).

When a user wear the jacket (11), put arms to the sleeve holes (27) of the jacket (11) and insert every latch plates into the corresponding buckles. (20-1) to (19-1), (20-2) into (19-2), (20-3) into (19-3), (20-4-E) into (19-4-L), and (20-4-R) into (19-4-R). After fasten up every buckles and latch plate, zipper (21) up.

FIG. 5-b is a front view of the out-door jacket (11) of the low altitude deployment parachute embodying the current invention. The appearance of the jacket (11) looks just like any other out door jacket except the compressed air container (7) and a part of the long HDPE film tube (8), (9) for compressed air conduit. The compressed air container is in active motion by opening a lever (7-1). The compressed air container and tube (8), (9) is firmly connected via proper connection method.

FIG. 5-c is a side view of the out-door jacket (11) of the low altitude deployment parachute (1) embodying the current invention. And FIG. 5-d is a rear view thereof. Since the rapid deployment system is comprised of; a connector (5), arms (6), HDPE film tubes (3), sheaths (4), and long HDPE film tube (8); which are all made of thin film and fabrics, packed volume of the canopy (2) is just same as those of canopy without a rapid deployment system. Therefore, the canopy (2) and rigging lines (12) are packed into a small sack (28), which is stitched to the out layer of the center portion (25) of the jacket (11). The small sack is open when a user pulls a band (29). Then the sack (28) is torn off along the loosely stitched line (30) to release the canopy (2) and tangle lines (12).

FIG. 6 is a schematic drawing of the mechanism how the canopy (2) of the outdoor jacket connected parachute (1) for low altitude deployment embodying the present invention is working. It takes only few seconds, less than 3 seconds, before a wearer of the parachute (1) reach to the ground when the wearer jumps out of a window of a building. Therefore, the canopy (2) should be deployed within 1 or 2 seconds.

When a user open the compressed air container by one touch, the air (30) from the container (7) burst into the HDPE film tube (8) reinforced with sheath (9). Then the film (8) and sheath (9) blows up into a tube shape and the air reaches to the connector (5) and distributes into the HDPE film tubes (3). As air is introduced in to the tubes (3), the tube is blown up and stretches the canopy by the pressure force of the air. The air (30) goes directly reach to the open end of the tube (3) and tries to open the canopy wide. Once the canopy (2) is opened, the air (31) blown from the underneath of the canopy (2) maintains the canopy in open state. Descending velocity of the parachute (1) is decreased by the buoyancy force.

What is claimed is:

1. An out-door jacket connected life parachute for low altitude deployment that is comprised of:
a canopy formed of pieces of fabric sewed together and has hole at the center thereof to allow air pass through, and
pluralities of HDPE (High Density Ploy Ethylene) film tubes, which are reinforced with sheaths made of same material of the canopy by heat sealing with a hot melt sealant of EAA (Ethylene Acrylic Acid copolymer) and extend from center of the canopy in a spoke-wise manner, and
a connector, which has pluralities of arms that are connected to the HDPE film tubes reinforced with sheaths made of same material, Nylon®, of the canopy and is made of HDPE film drum reinforced with same fabric of the canopy and locates at the center of the canopy, and
a compressed air container that is in active motion by opening a lever, and
a long HDPE film tubes reinforced with sheath made of same material of the canopy that connects the compressed air container and the connector, and
a harness firmly attached inside of an out-door jacket and is comprised of
two shoulder belts which are stitched to the inside of shoulder part of the jacket along the circumference of the shoulder, and
two shoulder branch belts, and
a chest belt that is horizontally stitched to inside of rear portion of the jacket just below the armpit of a wearer and 50 cm of both ends of the chest belt are not stitched and extended freely, and
a chest buckle that is installed to one free end of the chest belt, and
a chest latch plate that is installed on the other free end of the chest belt, and
a waist belt that is horizontally stitched to the inside of the rear portion of the jacket on a waist portion and 50 cm of both ends of the waist belt are extended feely, and
a waist buckle that is installed on one free end of the waist belt end, and
a waist latch plate that is installed on the other free end of the waist belt, and
two cross belts that are stitched to the inside of the rear portion of the jacket by crossing each other as “X” shape and upper ends of both of the cross belts are connected to bundle holder of the rigging lines and 50 cm of both lower ends of the cross belts are extended freely, and
a cross latch plate that is installed on a free lower end that locates at the left side of the drawing, and
another cross latch plate that is installed on a free lower end that locates at the right side, and
a back spinal belt that is vertically stitched to the center of the inside of the rear portion of the jacket and upper end of the back spinal belt meets with a horizontal belt that horizontally connects upper portions of the two shoulder belts and lower end of the back spinal belt is divided into two leg belts, and
a leg latch plate that is installed at the end of the leg belt, and
another leg latch plate that is installed at the end of the other leg belt, and
pluralities of rigging lines that connect the canopy and the harness.

2. An out-door jacket connected life parachute for low altitude deployment of claim 1, wherein the 75% of circumference of the HDPE film tube is reinforced with Nylon® sheath by heat sealing and the protons that are not adhered to the HDPE film tube are stitched to the fabric of the canopy along the sewing line.

3. An out-door jacket connected life parachute for low altitude deployment of claim 1, number of sewing lines is grater than the number of HDPE film tubes reinforced with sheaths.
